(19) United States
(12) Patent Application Publication
(10) Pub. No.: US 2015/0101464 A1
(43) Pub. Date: Apr. 16, 2015

(54) TORQUE TOOL WITH USE LIMITER

(71) Applicant: Brian James Cutler, Rowland Heights, CA (US)

(72) Inventor: Brian James Cutler, Rowland Heights, CA (US)

(21) Appl. No.: 14/511,699

(22) Filed: Oct. 10, 2014

Related U.S. Application Data
(60) Provisional application No. 61/889,781, filed on Oct. 11, 2013.

(51) Int. Cl. B25B 23/14

(52) U.S. Cl. CPC B25B 23/14
USPC 81/467

(57) ABSTRACT

A torque tool having a visible indicator indicating that a predetermined number of usages of the torque tool has occurred. The indicator is carried on a movable platform which is moved into alignment with a window in the housing of the torque tool by a gearing assembly ultimately driven by a torque shaft for applying torque to a fastener. The gearing assembly includes gears extending along less than the full extent of the gear, so that a point is reached wherein at least one of the gears disengages from another gear, such that further rotation of the last gear does not occur. The indicator is eventually displayed to signal exhaustion of permissible usages, but is not moved further to conceal the indicator by disengagement of at least one gear from another.

### CROSS-REFERENCE TO RELATED APPLICATION

This application claims the benefit of U.S. Provisional Application Ser. No. 61/889,781, filed Oct. 11, 2013, which is hereby explicitly incorporated herein by reference.

### FIELD OF THE DISCLOSURE

The present disclosure relates to torque tools, and more particularly, to a torque tool having an ability to display information pertaining to a number of performed uses of the torque tool.

### BACKGROUND

Inexpensive torque tools provide a practical way of assembling devices needing applied torque to be measured or limited. Inexpensive torque tools may have a limited useful life after which they do not work, or alternatively, become objectionably inaccurate.

### SUMMARY

There is disclosed herein a torque tool which addresses the above stated situation by providing an ability to display an advisory message operable to indicated that the torque tool has attained a maximum number of performed uses, to prevent users from relying on the torque tool after its accuracy has been exhausted.

To this end, the tool incorporates apparatus connected to a rotatable torque shaft which delivers torques to be applied to workpieces. The apparatus displays the advisory message after a predetermined maximum number of performed uses of the torque tool has been attained. The apparatus includes gearing which rotates a platform into view, the platform displaying the advisory message after a predetermined amount of rotation.

The advisory message may include a final advisory that the predetermined maximum number of performed uses has occurred, or alternatively may also include at least one intermediate advisory indicating approach of the point at which the predetermined maximum number of performed uses has occurred.

### BRIEF DESCRIPTION OF THE DRAWINGS

Various objects, features, and attendant advantages of the present disclosure will become more fully appreciated as the same becomes better understood when considered in conjunction with the accompanying drawings, in which like reference characters designate the same or similar parts throughout the several views, and wherein:

FIG. 1 is a perspective view of a torque tool, according to at least one aspect of the disclosure;

FIG. 2 is an exploded perspective view of the torque tool of FIG. 1, but fitted with a cap different from that illustrated in FIG. 1, according to at least one aspect of the disclosure;

FIG. 3 is a bottom plan view of the uppermost component illustrated in FIG. 2;

FIG. 4 is an exploded perspective view of components housed within a body and a handle of the tool of FIG. 1; and

FIG. 5 is an enlarged plan detail view showing some components seen at the center of FIG. 3.

### DETAILED DESCRIPTION

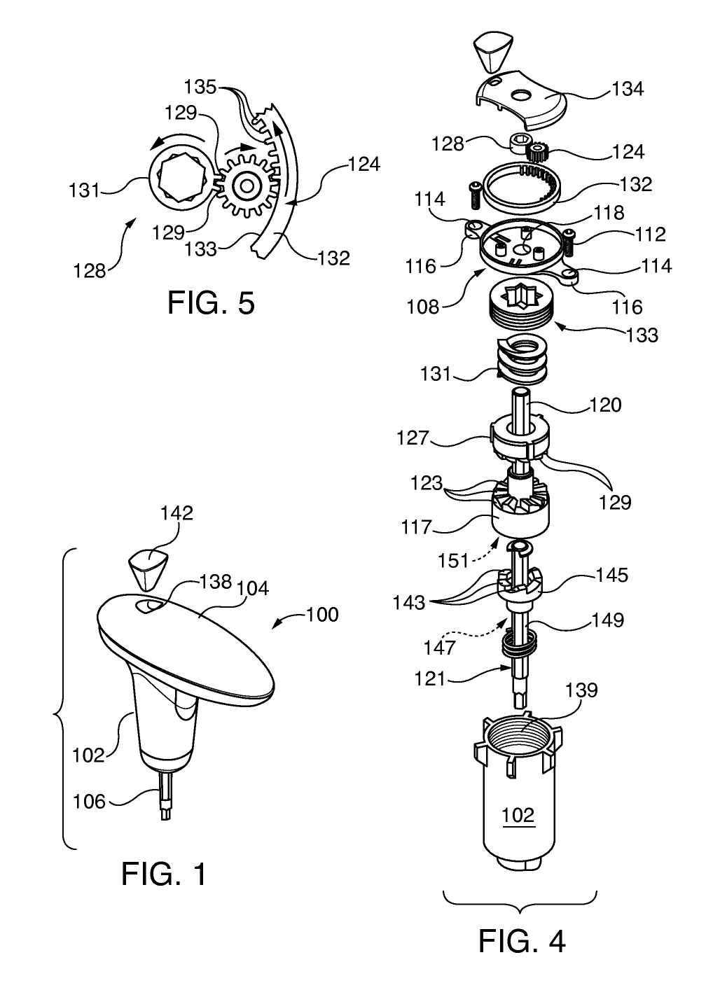

Referring first to FIG. 1, according to at least one aspect of the disclosure, there is shown a hand held torque tool 100 having a torque shaft 106 for applying a predetermined torque to an object (not shown), torque tool 100 having a predetermined usable service life. A predetermined useful service life will likely be necessitated by economics where torque tool is built for a limited number of usages, for example, where limited use, disposable tools displace tools intended for longer term use. Torque tool 100 comprises torque shaft 106 and torque limiting components acting on torque shaft 106 to limit torque applied thereby, and a use limiter discouraging torque tool 100 from being used after the predetermined usable service life has expired. Torque tool 100 further comprises a body 102 and a handle 104 collectively containing the torque limiting components and the use limiter. Torque shaft 106 projects from body 102. Body 102 and handle 104 enclose and protect the torque limiting components and the use limiter against incidental damage. As will become apparent hereinafter, handle 104 encloses functional components of torque tool 100 just as does body 102.

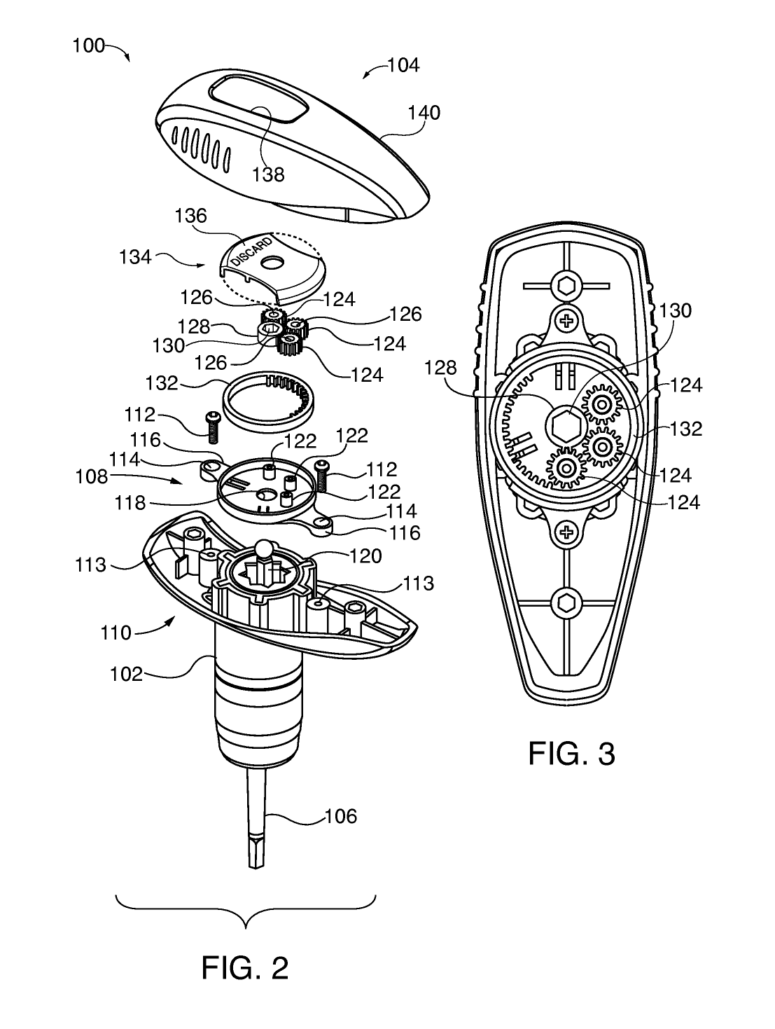

FIG. 2 shows functional components contained within handle 104. A structural support platform 108 may be fastened to a lower handle member 110 by bolts 112 which may be driven into bosses 113, the bolts 112 passing through holes 114 in ears 116 of structural support platform 108. Structural support platform 108 includes an opening 118 for passing an extension shaft 120 of torque limiting components (see FIG. 4). Torque limiting components are shown in FIG. 4.

In FIG. 4, the torque limiting components act on both extension shaft 120, which provides inputs for the use limiter, and also to limit torque applied to a drive shaft 121. The drive shaft 121 drives objects such as fasteners (not shown) to a specified torque value. As illustrated, distal end 125 of drive shaft 121 may bear drive elements, such as a star shaped bit, as manufactured by Torx®. The torque limiting components limit the amount of torque imparted to extension shaft 120 and drive shaft 121.

Torque limiting components for drive shaft 121 include a first member 117 having upwardly projecting teeth 123 (upwardly projecting as seen in FIG. 4), each tooth 123 including a ramp arranged at a small angle to a hypothetical plane perpendicular to extension shaft 120. The small angle may be for example five to thirty degrees from the hypothetical plane. First member 117 is fixed to body 102.

First member 117 has an opposed second member 127 bearing teeth 129. Teeth 129 are arranged in a complementary manner, interfitting with teeth 123 similar to teeth 129 but being opposite in pitch. When first and second members 117 and 127 are mutually rotated about an axis such as the rotational axis of extension shaft 120, in one direction, they will mutually repel or displace one another as the opposed ramps of teeth 123 and 129 slide across one another. Rotation of first member 117 rotates second member 127 until mutually displaced to the point that the apices of teeth 123 and 129 slide past each other. A spring 131 adjustably varies resistance to mutual displacement of first and second members 117 and 127, thereby varying the maximum torque which can be transmitted to second member 127 from first member 117. A threaded plug 133 is adjusted by engagement of its hexagonal central aperture 135 by a wrench (not shown) to adjust resistance of spring 131. Threads 137 of threaded plug 133 engage threads 139 of body 102. Torque imparted to extension shaft 120 is thereby limited.

Drive shaft 121 is limited as to imparted torque by a similar arrangement as that of extension shaft 120, except that orientation of components and direction of action are reversed, since drive shaft 121 faces a direction opposite that of extension shaft 120. First member 117 bears second teeth 151 (not visible, but structurally the counterparts of teeth 123) which face downwardly and interact with teeth 143 of third member 145. Third member 145 has a hexagonal central aperture 147 which cooperates closely with a hexagonal outer surface 149 of drive shaft 121. Consequently, third member 145 and drive shaft 121 rotate in tandem. Teeth 143 interact with teeth 151 in a manner similar to that of teeth 123 and 129. A spring 153 biases third member 145 along drive shaft 121 against first member 117. Mutual repulsion of first member 117 and third member 145 limits the amount of torque which can be imparted to drive shaft 121 by rotating body 102 (recalling that first member 117 is fixed to body 102). The maximum torque value is calibrated by determining position of body 117 along body 102 prior to fixing body 117 to body 102.

The use limiter comprises a visual indicator displaying advisory information indicating that the predetermined usable service life has expired. Without the visual indicator, users would be obliged to remember or otherwise track usages of torque tool 100. Torque tool 100 further comprises a usage monitoring arrangement which causes the advisory information indicating that the predetermined usable service life has expired to be displayed responsive to rotation of torque shaft 106. Rotations of torque shaft 106 are the true measure of uses. Hence basing the advisory information on rotations of torque shaft 106 provides a true indication of usages.

Torque tool 100 further comprises a gearing assembly comprising a central drive gear 128 rotated by rotation of torque shaft 106. Central drive gear 128 has gear teeth 129 (see FIG. 5) occupying less than the full extent of the circumference 131 of central drive gear 128. Torque tool 100 comprises a driven gear 132 having an internally facing surface 133 bearing teeth 135 along less than the full extent of internally facing surface 133. At least one idler gear 124 is located between central drive gear 128 and driven gear 132. The at least one idler gear 124 is configured to transmit rotation from central drive gear 128 to driven gear 132. Continued rotation of central drive gear 128 ceases to rotate driven gear 132 when gear teeth 129 of central drive gear 128 pass the point of engagement with the at least one idler gear 124.

The visual indicator is moved by driven gear 132 when driven gear 132 is being rotated from central drive gear 128 when gear teeth 129 of central drive gear 128 engage the at least one idle gear 124, and gear teeth 135 of driven gear 132 engage the at least one idler gear 124.

The visual indicator is not moved by driven gear 132 when gear teeth 129 of central drive gear 128 pass the point of engagement with the at least one idler gear 124 or when gear teeth 135 of driven gear 132 pass the point of engagement with the at least one idler gear 124.

The gearing assembly thereby actuates the visual indicator, and also causes the visual indicator to accurately reflect a use or usages of torque tool 100.

The usage monitoring arrangement comprises a window 138 in at least one of body 102 and handle 104. A cap or platform 134 bears indicia 136 corresponding to the advisory information. Platform 134 bearing indicia 136 is moved into alignment with window 138 such that indicia 136 is visible from the exterior of torque tool 100 through window 138, responsive to rotation of driven gear 132. Window 138 enables indicia 136 to be visible, with the visual indicator being protected within body 102 or handle 104.

The gearing assembly and its operation will be described in greater detail below. Bosses 122 projecting from structural support platform 108 rotatably support idler gears 124. Bosses 122 may serve as axles which occupy central throughbores 126 in idler gears 124 in close cooperation therewith, or alternatively, may receive fasteners (not shown) such as threaded fasteners which may be passed through central throughbores 126. If provided, the fasteners serve as axles about which idler gears 126 rotate.

Referring also to FIG. 3, a central drive gear 128 having a central opening 130 configured to receive and be rotated by extension shaft 120 engages idler gears 124. In FIG. 3, it will be seen that idler gears 124 transmit rotation from central drive gear 128 to a driven gear 132. As seen in FIG. 2, platform 134 is configured to snugly encircle and engage driven gear 132. Platform 134 bears indicia 136. Rotation of extension shaft 120 rotates central drive gear 128. As will be further explained hereinafter, this rotation is transmitted to driven gear 132 via idler gears 124, which then rotates platform 134.

Indicia 136 is visible through window 138 formed in an upper section 140 of handle 104. Indicia 136 provides a warning to the user of torque tool 100 that torque tool 100 has reached the end of its predetermined usable service life, and should be discarded and/or replaced. Indicia 136 may comprise a legend, such as “Discard” (as illustrated in FIG. 2), or “Do not use”. Instead of or in addition to a legend, indicia 136 may comprise a color scheme. Illustratively, a displayed portion of platform 134 may initially be colored black (indicating that torque tool 100 is new), with a transition to white (indicating that torque tool 100 is exhausted). Alternatively, gray coloring may be interposed between the white and the black to signal transition from new to exhausted. As a further alternative, other colors may be employed. Illustratively, yellow may be used to indicate that there are a predetermined number of cycles of use remaining, with red conveying a “Do not use” message. Indicia 136, platform 134, and window 138 collectively form the visual indicator to advise the user that the predetermined usable service life has expired.

Referring also to FIG. 5, rotation of extension shaft 120 results in rotation of central drive gear 128, idler gears 124 (only one idler gear 124 is shown in FIG. 5), and driven gear 132. It may be seen from FIG. 56 that as there are only two teeth 129 on central drive gear 128, one full rotation of the latter rotates idler gear 124 and hence driven gear 132 less than one full rotation each. Also, as idler gear 124 continues to rotate, it will disengage from driven gear 132 when teeth 135 pass the point of engagement with the teeth of idler gear 124. Hence, driven gear 132 and its associated platform 134 bearing indicia 136 cease to rotate at a point. The gearing assembly is calibrated such that this point occurs with the last permissible usage of torque tool 100 having been performed. Following such calibration, platform 134 may be glued to driven gear 132.

With the number of teeth 129 of central drive gear 128 being only one or two the advancement of platform 134 would be only one or two teeth 135 with each full three hundred sixty degrees of rotation of central drive gear 128. If it is desired to increase the number of teeth of advancement of the driven gear 132, e.g., to reduce the number of useable cycles of torque tool 100, additional teeth 129 can be added to central drive gear 128 to increase advancement with each full rotation of extension shaft 120. Driven gear 132 has a limited number of teeth 135 so driven gear 132 will only rotate a specified angle of rotation. Additional teeth 135 provide more cycles of count of useful life of torque tool 100.

Driven gear 132 may be constrained against spontaneous rotation when its teeth 135 do not engage idler gears 124. This may be accomplished by a coil spring (not shown) engaging driven gear 132 or platform 134, or by any other suitable source of friction opposing spontaneous rotation of driven gear 132.

Referring again to FIG. 1, torque tool 100 may further comprise a lens 142 in window 138, lens 144 magnifying indicia 136. Because indicia 136 may comprise very small lettering where indicia 136 comprises a legend, lens 144 may make reading the legend easier.

Unless otherwise indicated, the terms “first”, “second”, etc., are used herein merely as labels, and are not intended to impose ordinal, positional, or hierarchical requirements on the times to which these terms refer. Moreover, reference to, e.g., a “second” item does not either require or preclude the existence of, e.g., a “first” or lower-numbered item, and/or, e.g., a “third” or higher-numbered item.

It should be understood that the various examples of the apparatus(es) disclosed herein may include any of the components, features, and functionalities of any of the other examples of the apparatus(es) disclosed herein in any feasible combination, and all of such possibilities are intended to be within the spirit and scope of the present disclosure. Many modifications of examples set forth herein will come to mind to one skilled in the art to which the present disclosure pertains having the benefit of the teachings presented in the foregoing descriptions and the associated drawings.

Therefore, it is to be understood that the present disclosure is not to be limited to the specific examples presented and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims.

I claim:

1. A torque tool having a torque shaft for applying a predetermined torque to an object and having a predetermined usable service life, the torque tool comprising:
a torque shaft and torque limiting components acting on the torque shaft to limit torque applied thereby; and
a use limiter discouraging the torque tool from being used after the predetermined usable service life has expired.

2. The torque tool of claim 1, wherein the use limiter comprises a visual indicator displaying advisory information indicating that the predetermined usable service life has expired.

3. The torque tool of claim 2, further comprising a usage monitoring arrangement which causes the advisory information indicating that the predetermined usable service life has expired to be displayed responsive to rotation of the torque shaft.

4. The torque tool of claim 3, further comprising a body and a handle collectively containing the torque limiting components and the use limiter, wherein the torque shaft projects from the body.

5. The torque tool of claim 4, further comprising a gearing assembly comprising:
a central drive gear rotated by rotation of the torque shaft, the central drive gear having gear teeth occupying less than the full extent of the circumference of the central drive gear;
a driven gear having an internally facing surface bearing teeth along less than the full extent of the internally facing surface; and
at least one idler gear located between the central drive gear and the driven gear and configured to transmit rotation from the central drive gear to the driven gear, wherein
continued rotation of the central drive gear ceases to rotate the driven gear when the gear teeth of the central drive gear pass the point of engagement with the at least one idler gear, and the visual indicator
is moved by the driven gear when the driven gear is being rotated from the central drive gear when the gear teeth of the central drive gear engage the at least one idle gear and the gear teeth of the driven gear engage the at least one idler gear, and
is not moved by the driven gear when the gear teeth of the central drive gear pass the point of engagement with the at least one idler gear or when the gear teeth of the driven gear pass the point of engagement with the at least one idler gear.

6. The torque tool of claim 5, wherein the usage monitoring arrangement comprises:
a window in at least one of the body and the handle; and
a platform bearing indicia corresponding to the advisory information, wherein the platform bearing the indicia is moved into alignment with the window such that the indicia is visible from the exterior of the torque tool through the window responsive to rotation of the driven gear.

7. The torque tool of claim 6, further comprising a lens in the window, the lens magnifying the indicia.
